(19) United States
(12) Patent Application Publication
(10) Pub. No.: US 2012/0145572 A1
(43) Pub. Date: Jun. 14, 2012

(54) CONTAINERS ASSEMBLED IN FLUID AND CORRESPONDING PRODUCTION

(75) Inventors: Juergen Brugger, Vufflens-La-Ville (CH); Cristina Martin-Olmos, Los Angeles, CA (US); Alcherio Martinoli, Lausanne (CH); Gregory Mermoud, Veyras (CH)

(73) Assignee: ECOLE POLYTECHNIQUE FEDERALE DE LAUSANNE (EPFL), Lausanne (CH)

(21) Appl. No.: 13/265,044

(22) PCT Filed: Apr. 20, 2010
(86) PCT No.: PCT/IB10/51735

§ 371 Date: Dec. 29, 2011

Related U.S. Application Data
(60) Provisional application No. 61/170,673, filed on Apr. 20, 2009.

(51) Int. Cl. B65D 25/08; B32B 1/06; B32B 5/16

(52) U.S. Cl. 206/219; 428/402.2; 264/4

(57) ABSTRACT

A method for fabricating a fluid container, wherein at least two half containers are mated in said fluid to be contained in said container. This method allows the incorporation of prefabricated devices into each half containers as well as the functional coupling of these devices after mating of the half containers, thus resulting in a functional hybrid MEMS fluid container.

The present application claims priority to the previous application U.S. Ser. No. 61/170,673 the content of which is incorporated by reference in its entirety in the present application.

### FIELD OF THE INVENTION

The invention concerns the fabrication of at least two semi-containers (or half-capsules) that can be assembled in fluid, liquid and/or gas in such a way that, when the half containers are mated, they form a container (or a capsule) that entraps some amount of the fluidic environment they are floating in. This opens the possibility to release the trapped fluid later on.

More specifically, the invention concerns a fundamentally new method to create liquid-containing smart micro-containers with inherent functionalities that allow for a controlled release of the encapsulated fluid. The objectives can be summarized as follows
1. Thousands/millions of ‘semi-containers’ are fabricated by means of advanced wafer scale micromachining techniques and endowed with integrated sensing and action capabilities.
2. Pairs of the semi-containers (and potentially intermediate parts) are assembled within a functional liquid in order to encapsulate the liquid inside the self-closing container.

The filled containers are relocated to another destination, where the liquid is released upon a trigger signal.

### BACKGROUND OF THE INVENTION

Smart systems are able to gather information from the environment, to process it, and to perform a subsequent action. They are envisioned for applications in a broad variety of fields such as health care, information technology, environmental engineering, etc. In order to obtain such systems it is necessary to fabricate, assemble and package hybrid, multi-functional and multiple length-scale devices. Following the trend of miniaturization of devices, packaging and assembly are becoming key issues in manufacturing such complex systems.

Today's assembly and packaging techniques include robotic pick-and-place methods, wafer-scale bonding and flip-chip methods to construct mechanical and electrical connections between different, individually fabricated sub-systems, or between components and an interface board. However, those techniques are not adequate to deal with the upcoming needs of device assembly. Indeed, future manufacturing approaches will need to be highly parallel, cost-efficient and down-scalable, while remaining flexible and controllable. Alternative techniques address the assembly and packaging challenge by means of fluidic mediated self-assembly (FSA) as illustrated in the publication H. J. J. Yeh et al., Photonics Technology Letters, IEEE (1994) 6, 706-708 and M. Boncheva et al., Pure and Applied Chemistry (2003) 27, 621-630 (the content of which is incorporated by reference in its entirety in the present application).

The state-of-the-art of FSA uses capillary forces between a surface and an assembling unit to position and deploy the parts on the target surface. The FSA technique is appropriate when the individual pieces are either too small or too numerous to be assembled using pick-and-place methods. Remarkable results have already been achieved to build functional integrated systems by FSA, e.g. a sequential 3D self-assembly of microfabricated silicon parts in an aqueous solution using hydrophobic interaction, repulsive double-layer and van der Waals forces, see the publication H. Onoe et al., Small (2007) 3, 1383-1389. A “railed microfluidics” method allowed guiding and assembling microstructures inside fluidic channel, see the publication S. E. Chung et al., Nature Materials (2008) 7, 581-587 (all incorporated by reference in their entirety in the present application). Common to the FSA approaches so far is that the liquid has primarily been used to mediate the forces (mainly capillary) used for the assembly processes.

U.S. Pat. No. 4,483,616 (the content of which is incorporated by reference in its entirety in the present application) discloses containers for small quantities of liquids. More specifically, the container comprises an elongated housing having a fluid receptacle disposed in the upper end thereof. The dimensions of the receptacle are substantially less than the overall dimensions of the housing, thereby facilitating the handling of the container and inhibiting evaporation of the liquid therein.

U.S. Pat. No. 4,931,284 (the content of which is incorporated by reference in its entirety in the present application) discloses a completely novel type of micro-capsules, viz. such capsules where an encapsulated hydrophobic or lipophilic substance is surrounded by polar solid crystals of polar lipids which expose their hydrophilic face outwards and their hydrophobic face turned inwards towards the hydrophobic or lipophilic substance.

Other prior art publications include the following articles, all incorporated by reference in the present application:

| | |
|---|---|
| 1. | Randall, C. L., et al., 3D lithographically fabricated nanoliter containers for |
| | drug delivery. Advanced Drug Delivery Reviews, 2007. 59(15): p. 1547-1561. |
| 2. | Whitesides, G. M. and B. Grzybowski, Self-assembly at all scales. Science, |
| | 2002. 295(5564): p. 2418-2421. |
| 3. | Boncheva, M., D. A. Bruzewicz, and G. M. Whitesides, Millimeter-scale self- |
| | assembly and its applications. Pure and Applied Chemistry, 2003. 75(5): p. |
| | 621-630. |
| 4. | Srinivasan, U., D. Liepmann, and R. T. Howe, Microstructure to substrate self- |
| | assembly using capillary forces. Journal of Microelectromechanical Systems, |
| | 2001. 10(1): p. 17-24. |
| 5. | Zhu, T., et al., Mechanics of a process to assemble microspheres on a |
| | patterned electrode. Applied Physics Letters, 2006. 88(14): p. 3. |
| 6. | Onoe, H., K. Matsumoto, and I. Shimoyama, Three-dimensional sequential |
| | self-assembly of microscale objects, in Small. 2007. p. 1383-1389. |
| 7. | Zheng, W. and H. O. Jacobs, Fabrication of multicomponent microsystems by |
| | directed three-dimensional self-assembly, in Adv Funct Mater. 2005. p. 732-738. |
| 8. | Grzybowski, B. A., J. A. Wiles, and G. M. Whitesides, Dynamic Self-Assembly of |
| | Rings of Charged Mettalic Spheres. Phys. Rev. Lett., 2003. 90(8): p. 083903-1- |
| | 083903-4. |
| 9. | Boncheva, M., et al., Magnetic self-assembly of three-dimensional surfaces |
| | from planar sheets. Proceedings of the National Academy of Sciences of the |
| | United States of America, 2005. 102(11): p. 3924-3929. |

### PRINCIPLE OF THE INVENTION

The concept of the present invention goes much further than FSA by using the liquid not only for mediating the self-assembly, but also for trapping the liquid inside hollow micro-containers for further remote use.

More specifically, in the present invention, the containers are assembled within a functional liquid such that the said liquid is encapsulated by the self-closing containers. The filled containers are then relocated when used and the encapsulated liquid is released by the use of a trigger means that, for example, opens the assembled containers.

For instance, such containers could be used as smart markers and sensors that highlight contaminated areas in an environment by releasing luminescent nanoparticles. Moreover, they could be deployed as sensor-based environmental regulators: e.g. if the environment becomes too acidic or basic, the devices could release a substance that equilibrates the pH. With this invention, the large number of micro-containers available will allow to design easily heterogeneous systems endowed with, for instance, antagonistic actions. These devices could also capture nanomaterial suspensions in fluid and transport them to a remote location as well, either for analysis (in the context of diagnosis) or destruction (in the context of environmental cleaning or purification). Due to the potentially very large numbers of smart liquid capsules, redundancy and fault tolerance can be optimized for any of the above-mentioned applications. The capsules could also be equipped with a unit (e.g. a RF transceiver, a sensor, an actuator, etc.), which will allow to control the liquid-releasing operation either via a central external unit (e.g., electromagnetic field, light irradiation, radiofrequency signal, etc.) or by an on-board signal generated by a dedicated sensor connected to the liquid-releasing actuator.

To summarize, the present idea is a radically new way of manufacturing and using liquid-filled free-floating smart micro-capsules.

A further innovation is to fabricate hybrid devices that are ‘intelligent’ because of the three following assets:

(i) they are smartly designed in terms of material, shape, geometry, and size in order to achieve complete functionality;

(ii) they are capable of self-assembly (free or template-based), using a parallel, scalable, and cost-effective packaging method in three dimensions;

(iii) they are able to modify their behaviour using either endogenous sensors or a perceived external trigger in combination with some simple logic.

Moreover, the expected outcome will be cost-efficient and flexible for a wide range of applications. Embedding sensors, actuators and logic in a micro-container filled with liquid has never been reported in the literature. Indeed, even though some authors report encapsulation of liquid in self-folding structures¹, they do not offer solutions regarding the actuation of these devices. The present invention allows fulfilling this challenge. ¹ H. Ye et al., Angew. Chem., Int. Ed (2007) 46, 4991-4994 and C. L. Randall et al., Advanced Drug Delivery Reviews (2007) 59, 1547-1561

### BRIEF DESCRIPTION OF THE DRAWINGS

The present invention will be better understood by the description of several embodiments and of the drawings which show

FIG. 1a, 1b, 1c illustrate in schematic ways the principle of the invention;

FIGS. 2a, 2b and 2c illustrate schematic drawings of possible configurations of the invention;

FIGS. 3a, 3b, 3c and 3d illustrate a schematic in fluid bonding process;

FIGS. 4a and 4b illustrate schematic self-assembly possibilities;

FIG. 5 illustrates schematically a fabrication process of the containers;

FIGS. 6a to 6f illustrate images of containers produced in accordance with the principle of the present invention.

### DETAILED DESCRIPTION OF THE INVENTION

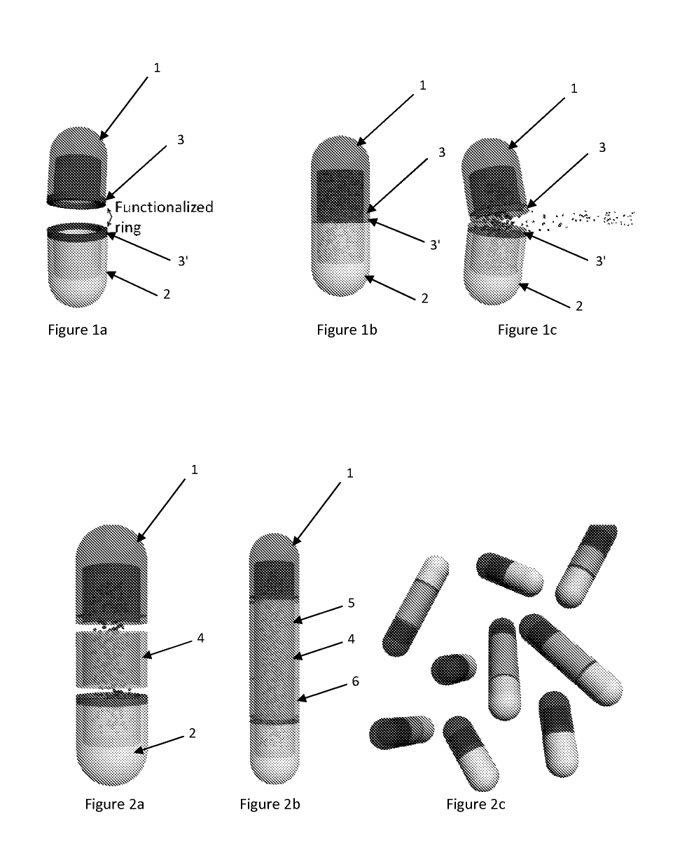

FIGS. 1a to 1c illustrate the principle of the invention, more specifically, schematic views of the containers (or capsules) in different states.

FIG. 1a: each half 1, 2 of the container may have its own shape, color, and material. A functionalized ring 3,3′ is incorporated in order to mediate the assembly between the parts forming the container. Examples of such functionalized ring 3, 3′ are described in the following specification.

FIG. 1b illustrates a container produced with the method of the present invention: performing the assembly of the semi-containers 1, 2 in fluid allows trapping a small amount of the fluid. More specifically, FIG. 1b illustrates this state where fluid has been trapped in a container and said container may then be brought where it is needed.

FIG. 1c: the trapped fluid can be released later in a different environment, on demand, by separation of the parts 1, 2 forming the container. Preferably, this release is triggered by a specific means, this releasing mechanism being described in more detail further in the present application.

The parts 1, 2 forming the containers may be different (in shape, color, material, functionality) or exactly similar and/or symmetrical or not. At least one of them must be able to contain some fluid. They can incorporate a linking material (as for example the ring 3, 3′ shown in FIG. 1a) in order to control and mediate the attraction between the half containers 1, 2, but also to allow their aperture when is desired. Of course, other equivalent means are possible to allow or promote the assembly of the parts 1, 2 of the container and also their separation or disassembly when desired (for example when certain conditions are met or through a trigger means).

One other feature of the present approach is the possibility to build different types of containers (also named capsules) by combining more pieces or parts. The pieces that can be allocated in between the two parts 1, 2 illustrated in FIGS. 1a to 1c may also have internal walls in order to trap more than one type of fluid in each final container. Some examples of such designs are shown in FIGS. 2a to 2c where additional parts 4, 5, 6 are placed between the two halves 1, 2. The parts may be assembled with a functionalized ring as described in reference to FIG. 1a for example. Of course, additional parts 4 to 6 may have any size as wished.

The trapping of more than one fluid in the containers (for example when one of the parts comprises an additional wall) will involve a first assembly of two parts in a first fluid, in order to trap a first fluid in the two parts being assembled, then a second assembly of the first two assembled parts in a second fluid with a further (i.e. third) part. This process can of course be repeated as often as necessary in successive steps to form the final container with the desired number of fluids contained in it, in accordance with the principles of the present invention.

Although many different shapes may be taken into account to form the container and container parts, there is one particular shape especially convenient for avoiding undesired surface contact between the capsule parts: round surfaces. Hence, cylinders with round end as shown in FIGS. 1a to 1c and FIGS. 2a to 2c have a suitable shape to favor the correct configuration assembly between the semi-containers. Of course, this is only an example and should not be considered as a limitation on the shapes of the containers.

Also, the parts of containers (halves and/or auxiliary part) that are assembled may have different shapes and sizes. They can be made of different materials or the same material. This principle also applies to the auxiliary part that could be added to increase the quantity of fluid present in a closed container or capsule, or that may be used to contain another (second) fluid in the container or capsule. In addition, although the notion of capsule has been used in the present specification, this should not be regarded as a limiting concept but meaning a container suitable for a fluid or other similar product.

FIGS. 2a to 2c illustrate schematic drawings of some of the possible configurations where the container is made of more than two halves (in this case three parts or more as illustrated).

By fabricating and adding different auxiliary pieces, it is possible to configure different lengths of final capsules allowing the capture of larger amounts of fluid. In addition (alternatively), it is possible by using the principle of the invention to carry out an encapsulation of different fluids in one string.

Proposed Method for the Assembly

The main objective is assembling the two semi-containers in fluid. This is common to both approaches described below. Each of them has its advantages, the first one being superior in terms of yield while the second one in terms of cost-effectiveness.

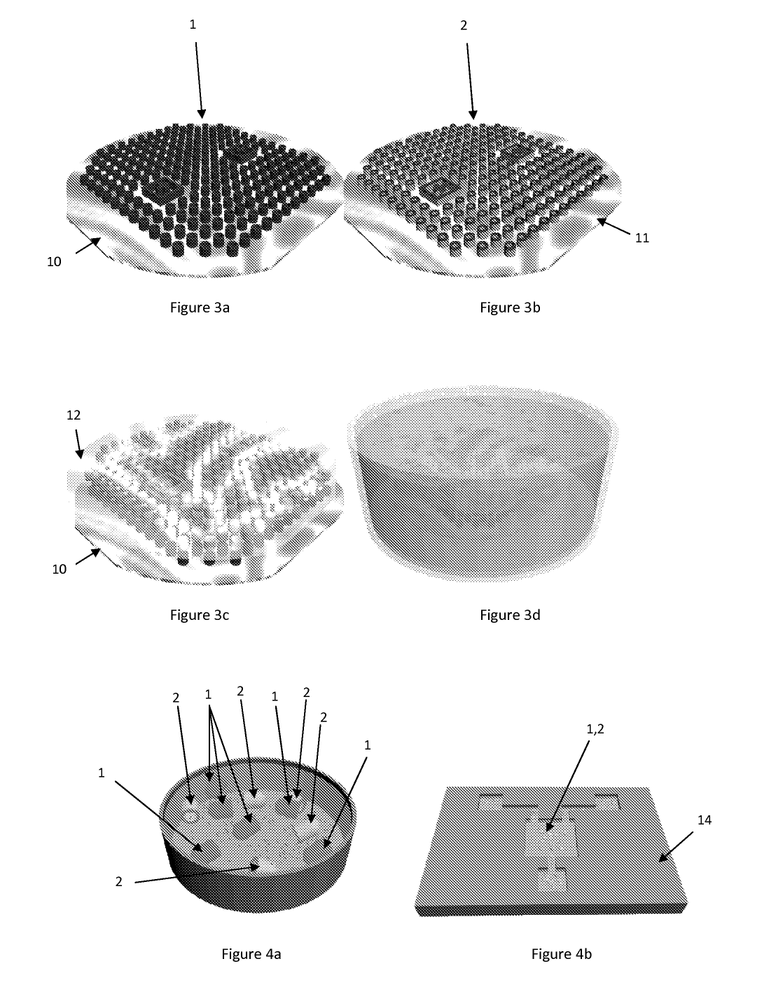

a. In-Fluid Bonding
One option to assemble both parts of the containers is to align two fabricated wafers in-fluid. This is possible using an alignment stage in a fluid container and using transparent wafers (for example glass or other equivalent materials). After the alignment, both wafers can be exposed under UV light to fully crosslink the photosensitive polymer that is used to form the container parts or heated in a hot plate to cure it thermally. Other equivalent options can be also contemplated in the frame of the present invention, depending on the material used to form the container parts.
FIGS. 3a, 3b, 3c and 3d illustrate a schematic in fluid bonding process. Half-containers 1 or 2 are fabricated by conventional micromachining methods on two distinct wafers 10, 11 (see FIGS. 3a and 3b); each of those wafers 10, 11 may undergo different, possibly incompatible, manufacturing processes.
Then, these two wafers 10, 11 need to be aligned (see FIG. 3c), and finally bonded in a fluidic environment (see FIG. 3d) in order to form the liquid-containing containers.
FIGS. 3a to 3d are schematic drawings illustrating the in-fluid bonding process. More specifically, FIG. 3a represents a set of half containers (for example the top part 1) just before their release held in a substrate 10.
FIG. 3b represents also a set of the other half containers (for example the bottom part 2) held in a substrate 11 until stuck to a transparent substrate 12.
In FIG. 3d one of the wafers of FIG. 3a or 3b is turned around and aligned with the other and this step of the process has to be done in-fluid as shown in FIG. 3d in order to trap the fluid inside the containers thus formed.
Then, by an appropriate step (for example curing or heating as explained above) the containers are formed and may be detached from the wafers or substrates 10, 11.

b. In-Fluid Self-Assembly
The second option comprises favoring the in-fluid self-assembly between both half parts, a self-assembly in which basic units form a structure using interaction between them.
The self-assembly can be performed in a stochastic way, as shown in FIG. 4a., where the half containers 1, 2 are placed in a liquid receptacle 13 and their mating is provoked by gentle agitation, such as stirring, heating, or shaking or another equivalent process.
The half containers 1, 2 can be also provided with directed mobility by the channels of a microfluidic network system 14 as illustrated in FIG. 4b. In this case the mating probability is increased.

Proposed Methods to Keep the Content in the Capsule

Self-assembly between half containers needs an interacting force that keeps the two parts together. In the same sense, for the in-liquid bonding, a linking material is required that will keep the capsule closed.

Forces that can maintain the capsule assembled include, among others:
Hydrophobic force in polar fluid environments: in this case, the ring (3, 3′ see FIGS. 1a-1c) must be made of a highly hydrophobic material such as some specific Self-Assembled Monolayers (SAM) or Teflon, for instance.
Van der Waal force or interaction: this force can be attractive or repulsive between molecules. The capsules can have a functionalized ring (3,3′) at the end that could maximize the strength of this force.
Covalent forces: this force can interact in case of having covalent bounds.
Electrostatic Induction: if the electrical charge in the capsule can be redistributed by the influence of nearby charges.
Electromagnetic force: if for example, the ring 3,3′ is made of ferromagnetic material and each half container is polarized in such a way that both halves will attract each other.
Mechanical clamp: in order to keep the pieces or parts together.
Etc. . . . As will be understood, other equivalent possibilities may be envisaged in the frame of the present invention and the examples given above should not be construed in a limiting manner.

The containers can be fabricated using a lot of different materials such as polymers, resist, silicon, etc. Concerning the fabrication of the ring 3,3′, one example can be to use a glue-like material that can be either cross-linked or cured in order to maintain half containers together and allow also to be removed under specific conditions, thus triggering the aperture of the capsule and the release of the captured fluid when certain conditions are met.

Obviously other materials and methods can be used depending on the type of assembly means being used. Different assembly means may also be used in the configurations where there is more than one specific fluid trapped in the containers, such as illustrated in the FIGS. 2a to 2c.

Proposed Methods to Release the Content of the Capsules

The method to release the content of the capsules depends directly on the method used for assembling and the interaction used to keep the half containers bonded together.

For example, in the case where the interacting force is the hydrophobic one, a method for releasing the content could be based on the change of the fluid environment, from a polar to a non-polar one. Another method is, in case the interacting force is an electromagnetic one, to induce a change in the electromagnetic field applied to the environment so that, in turn, it can influence on the attraction force between the two semi-containers. A third possible method of releasing the content of the capsules is to use solvents that can act on the capsules, dissolving a part of the capsule (or the capsule itself), such as the functionalized ring described above. Of course, other methods that are not listed here can be applied for releasing the content of the capsules depending on the interaction force and the assembly method used.

Smart Triggering for the Release of the Content of the Capsules

The present approach enables the incorporation of sensors (e.g., chemical sensor, Hall sensor, pressure sensor, etc.) and their actuator counterparts (e.g., RF emitter, LED, piezoelectric actuator, etc.) in the assembled container. The sensors can be used for the detection of chemical substances or specific environmental condition (e.g., pressure, temperature, etc.). Then, upon detection of the target condition, the actuators can trigger the release of the content of the container. This makes the smart container capable of reactive behavior, which can be crucial to certain applications (e.g, drug delivery, fertilization, waste treatment, etc.).

Proof on Principle

In previous experiments, the feasibility of this technique has been demonstrated by achieving the self-assembly of long chains of fabricated hollow cylinders. Volumes that can be contained by these micro containers can range from 20 μl to 0.2 μl. Mostly it will depend on the height and the diameter of the final container.

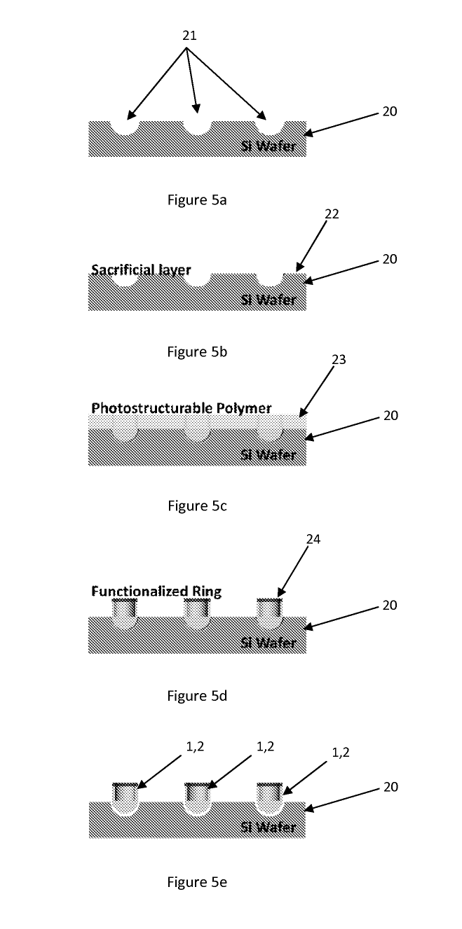

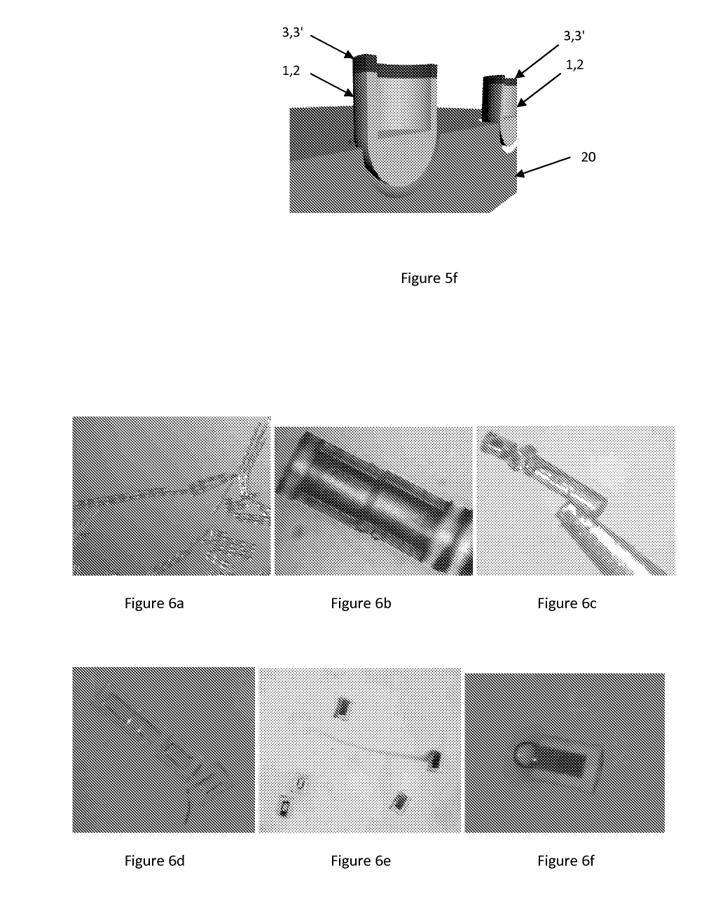

The process used to fabricate the container parts is illustrated in FIGS. 5a to 5f.

In FIG. 5a starting from a 100 mm P-Silicon wafer 20, a standard photoresist step is performed to define areas to be etched. A dry Reactive Ion Etching (DRIE) with etch shape control is carried out in order to obtain the desired semispherical shape 21 at the bottom in the wafer 20.

FIG. 5b illustrates the deposition step of a sacrificial layer 22, for instance an aluminum layer on the wafer 20.

FIG. 5c illustrates the deposition of a thick layer 23 of photostructurable polymer such as SU-8. The viscosity of this polymer will uniformly fill the silicon mold. The shape of the semi-containers is defined by UV exposition.

FIG. 5d illustrates the deposition of a functionalized layer 24 on top of the polymer 23, for example in the shape of a ring that corresponds to the rings 3, 3′ illustrated in FIG. 1a. This layer can be spin coated if it is a photostructurable polymer, stencil evaporated if it is a metal, deposited if it is a SAM. The development of the photostructurable polymer takes place when it is more convenient.

FIG. 5e illustrates the removal of the sacrificial layer etch to release the half containers 1 (or 2) formed by the steps of the method.

FIG. 5f illustrates a three-dimensional drawing of the half containers 1 (or 2) section during its fabrication (for example as in FIG. 5e) with a ring 3 (or 3′) according to the principle of the invention as described in the present applicaiton.

FIG. 6 depicts some results of the first generation of fabricated semi-containers. They are optical microscope captions of fabricated semi-containers. In this particular case, the half containers are made of hollow cylinders with a flat surface in the bottom. The photostructurable polymer used in this case is SU-8.

FIG. 6a demonstrates the possibility to form very long chains of self-assembled cylinders. More specifically, FIG. 6a illustrates 100 um diameter structures aligned by self-assembly in DI water.

FIG. 6b is an optical zoom of one self-assembled capsule after being dried, more specifically a 200 um diameter structure assembled in blue tinted DI water, showing some ink trapped. It can be seen from this image how the capsules can capture blue ink from the host liquid where they were self-assembled.

FIG. 6c emphasizes the strength of this interaction that allows one to easily handle the formed capsules with tweezers and to transport them into a new host liquid and illustrates 200 um diameter capsules assembled in blue tinted DI water and held in air by tweezers.

FIG. 6d illustrates 200 um diameter capsules immersed in DI water.

FIGS. 6e and 6f demonstrate the feasibility of the release of their content, in this specific case, blue ink. More specifically, FIG. 6e illustrates 200 um diameter semi-containers releasing the trapped blue ink in isopropanol and FIG. 6f illustrates 200 um semi-container releasing blue ink in blue tinted DI water

The manufacturing of Micro 3D multi-functional containers is a key technology for future integrated systems that allow unprecedented degree of complexity and miniaturization in the field of information, bio-medical, chemistry and environmental technology. In particular, such integrated systems will enable non-invasive smart drug delivery devices and chemical recognition.

In addition, the proposed invention has two advantages for their commercialization and adaptation to the current market. Firstly, the technology for the fabrication of the semi-containers is well known as cost-effective. Secondly, the procedure used to form the capsule allows reducing the waste of the material trapped in the containers.

Potential applications of the present invention include, among others:
On-demand drug delivery: The possibility to release drugs on-demand offers the possibility to administer effective therapeutics with minimal side effects.
Chemical encapsulation: Similarly to the drug delivery, an excess of a certain chemical species in an environment can be reduced by its encapsulation in the half containers. They can also be useful as a media to transport fluids from one environment to the other in a controlled way.
Chemical reaction: The inclusion of active substances in the containers that can react with targeted undesirable chemical species may enable the neutralization of some undesirable substances or, on the contrary, the catalysis of some desired chemical reaction in a controlled fashion.
Environmental regulation: The chemical species contained in the capsules can possibly regulate the external conditions by modifying the environment. For example, if the environment becomes too acidic or basic, the capsule can release a substance that equilibrates the pH. Another example can be for cleaning the environment by releasing a certain type of bacteria that would be contained in the capsules/containers.

The containers also provide an attractive platform for the integration of additional features such as sensing and actuation capabilities. In principle, the present approach allows the integration of any type of MEMS devices into the half-containers, as well as the functional coupling of these devices after mating of the half-containers. Another crucial advantage of the method is that each half-container may be endowed with MEMS devices that are incompatible with each other in terms of manufacturing process, thus resulting with a hybrid device.

Of course, the examples given are illustrative embodiments not to be considered in a limitative way. It is possible to use equivalent means to achieve the same goal.

1. A method for fabricating a fluid container, wherein at least two half containers are mated within said fluid to be contained in said container.

2. The method as defined in claim 1, wherein said at least two half containers are each attached to supports and said supports are aligned to mate said half containers.

3. The method as defined in claim 1, wherein said at least two half containers are mated stochastically.

4. The method as defined in claim 3, wherein the stochastic mating is enhanced.

5. The method as defined in claim 4, wherein the mating enhancement is caused by external means or by using confinement for enhancing the encounters.

6. The method as defined in claim 4, wherein the mating enhancement is caused by means present on said half containers.

7. The method as defined in claim 1, wherein said two half containers are mated to an auxiliary part.

8. The method as defined in claim 1, wherein at least one of said half containers or auxiliary part is closed and contains another fluid.

9. A container produced by the method as defined in claim 1.

10. A container comprising at least two halves, each comprising a functionalized ring as linking element between said halves.

11. The container as defined in claim 9, wherein the ring is made of a hydrophobic material.

12. The container as defined in claim 9, wherein the ring is made of a ferromagnetic material.

13. The container as defined in claim 9, wherein the ring is made of a material that can be cured or crosslinked.

14. The container as defined in claim 9, wherein it comprises at least one auxiliary part between said halves.

15. The container as defined in claim 9, wherein said halves and said auxiliary part have different sizes.

16. The container as defined in claim 9, wherein it comprises releasing means for releasing the fluid contained in said container.

17. The container as defined in claim 16, wherein said container is endowed with sensors and their actuator counterparts for release upon detection of given target conditions.
